(19) United States
(12) Patent Application Publication
(10) Pub. No.: US 2019/0221235 A1
(43) Pub. Date: Jul. 18, 2019

(54) Screen capture video

(71) Applicants: Edward D. Mclean, Lockhart, TX (US); James Edward Mclean, JR., Charlotte, NC (US)

(72) Inventors: Edward D. Mclean, Lockhart, TX (US); James Edward Mclean, JR., Charlotte, NC (US)

(73) Assignee: Mcleanics Technology Corporation

(21) Appl. No.: 15/732,887

(22) Filed: Jan. 16, 2018

(51) Int. Cl. G11B 27/02

(52) U.S. Cl. CPC G11B 27/02; H04B 1/3833

(57) ABSTRACT

The Screen Capture Video (SCV) is a system for mobile communications that enables a mobile communication device such as, a smart phone, cell phone, tablet, or smart watch, to capture and store/record the user's activities, sessions, or events. And, once activated, the SCV will run in the background of the user's current activity or event being worked on or used on the mobile communication device. Therefore, enabling said mobile communication device to capture and store/record the user's complete activities, sessions, or events, online or offline, for later uses. The user of the mobile communication device my capture his or her activities while working with or navigating through a program, application, game, or any other types of activities. Then, revisit these captured/recorded sessions for later viewing or editing, which includes cutting and pasting, adding graphics or text, deleting certain parts, etc.

### CROSS REFERENCE TO RELATED APPLICATION

This application is related to the Screen Capture Video Provisional Patent Application No. 62/497,819 filed on Dec. 5, 2016.

### STATEMENT REGARDING FEDERAL SPONSORED RESEARCH

None Applicable.

### REFERENCE TO SEQUENCE LISTING, TABLE, OR A COMPUTER PROGRAM LISTING COMPACT DISC APPENDIX

None Applicable.

### BACKGROUND OF INVENTION

The Screen Capture Video (SCV) is in the field of mobile communication technology, i.e. smart phones, cell phones, tablets, etc. Prior to the invent of the SCV, current mobile communication technology did not allow or permit a user to capture and store/record the user's complete mobile communication activities, sessions, or events, online or offline, for later use. Therefore, a user was unable to review, learn, use as a teaching tool, or use as a sales aid, his or her prior mobile communication activities, sessions, or events, the SCV will help overcome such situations.

### BRIEF SUMMARY OF THE INVENTION

The Screen Capture Video (SCV) is a mobile communication system attached to, embedded or installed within, a mobile communication device such as, a smart phone, cell phone, tablet, or a smart watch. The SCV will enable said mobile communication device to capture and store/record a user's complete activities, sessions, or events, online or offline, for later use by the user.

### BRIEF DESCRIPTION OF THE SEVERAL VIEWS OF THE DRAWINGS

FIG. 1, is the Block Diagram View of the invention. In this figure, the SCV is shown as a mobile communication device incorporating the functions of the SCV. This figure also shows the type of user's activities being captured by the SCV as an internet session, the user working within a software program or App, the user playing a video game, and a training session recorded by the video camera and microphone of the user's mobile communication device. Once these user activities are captured by the SCV, these captured events will be temporary stored within a file on the user's mobile communication device, the user will have the option to permanently store said captured events on the mobile communication device if the user so elects. However, the user may elect to upload the captured events to a Platform, Network, or Server for temporary or permanent storage.

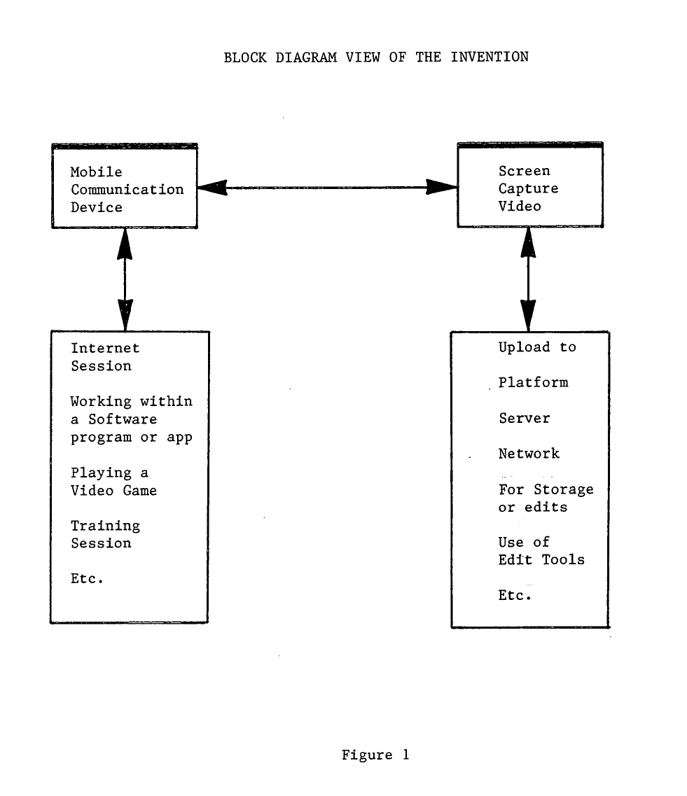

FIG. 2, is a Flow Chart of a user's activity being captured by the SCV. In this figure, the mobile communication device is a Smart Phone. Also, this figure depicts the user working in a software application, which consist of a financial spread sheet. The “means” are depicted as lines with arrows heads pointing in the direction of data flow. The SCV functions that are depicted in this figure is the external (stand alone) version of the SCV, which is shown encased within the dashed lines. The stand alone SCV will attach to a mobile communication device (smart phone) by a standard connection means such as, a USB connector. This figure also shows a wireless connection means such as, BLUETOOTH or WIFI. Although this figure shows the SCV as a stand alone device, the SCV can be incorporated or embedded within the circuitry of the mobile communication device. Once the user begins working with the software application (financial spread sheet), the user, at any time, may activate the SCV by pressing the “activation icon” of the SCV's software. Once activated, the SCV will run in the background of the current “financial spread sheet” being worked on by the user, capturing all of the user's activity until the user deactivates the SCV. Deactivation can occur at any time upon the user pressing the deactivation icon of the SCV's software. The activation/deactivation icons will be conveniently located on the mobile communication device's screen for easy access by the user. Once the activity is completed and the user has deactivated the SCV, the captured activity is temporary stored in a file on the mobile communication device. The user will then be able to playback the captured activity by means of a playback feature, and then edit the captured activity by means of the editing tools of the SCV. Upon completion, the user will be able to permanently store the captured activity on the mobile communication device, or upload the captured activity to a Platform, Network, or Server. If the user elects to upload the captured activity to the SCV's platform, the user will have available more advanced editing tools, clip arts, graphics, and photo galleries to further edit or manipulate the captured activity.

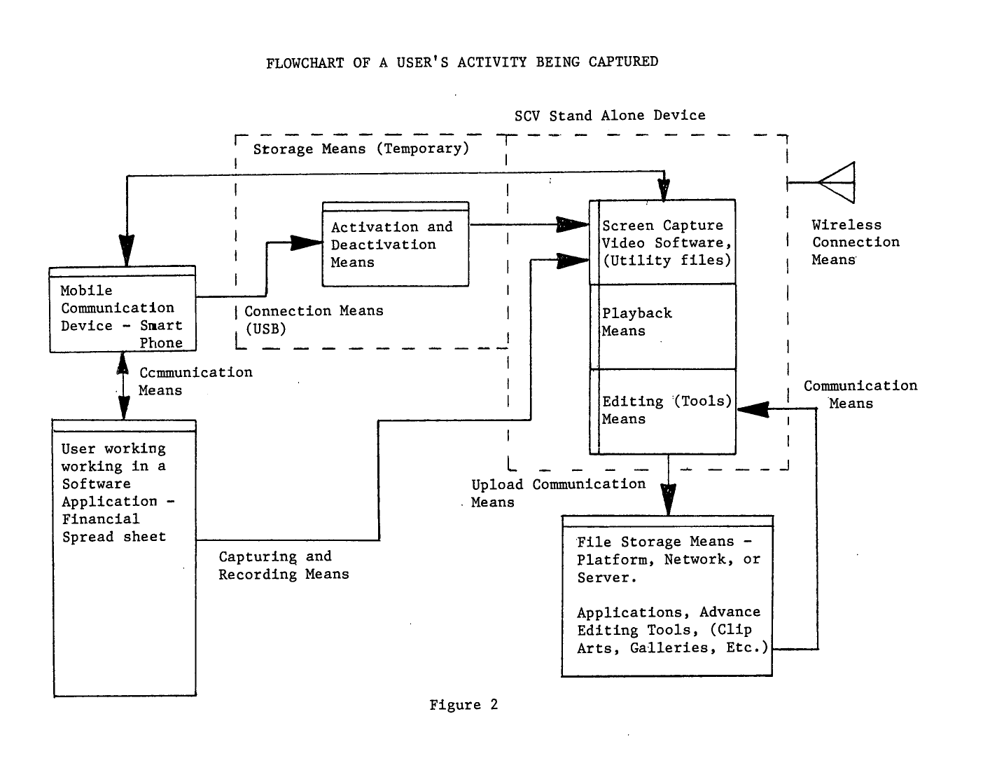

FIG. 3, is the Attachment Version View of the invention. This figure depicts the SCV being attached to a mobile communication device, which is a Smart Phone. The SCV is attached by means of a USB connector being inserted within the USB port of the mobile communication device (smart phone). Once attached to the mobile communication device and the user activates the SCV, the SCV will run in the background of the activity or event that the user is currently engaged or working in, and will capture and temporarily store said activity or events for later use by the user.

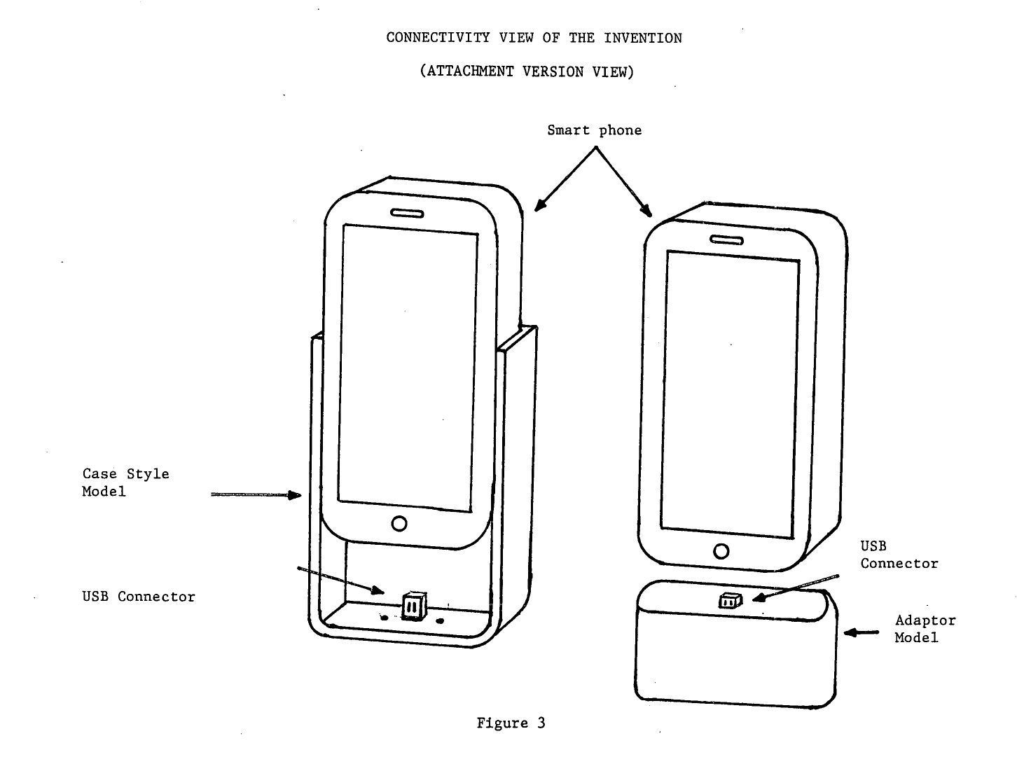

FIG. 4, is a depiction of the SCV embedded or incorporated within the circuitry of a mobile communication device (Smart Phone). The SCV may be installed within a mobile communication device in the case of a program or application. All of the features and functions of the SCV are controlled by software, utility files, or Applications installed or programmed within the mobile communication device. The storage means is the internal memory of the mobile communications device, with the capability of uploading captured activities and events to a platform, network, or server for external storage, editing, etc.

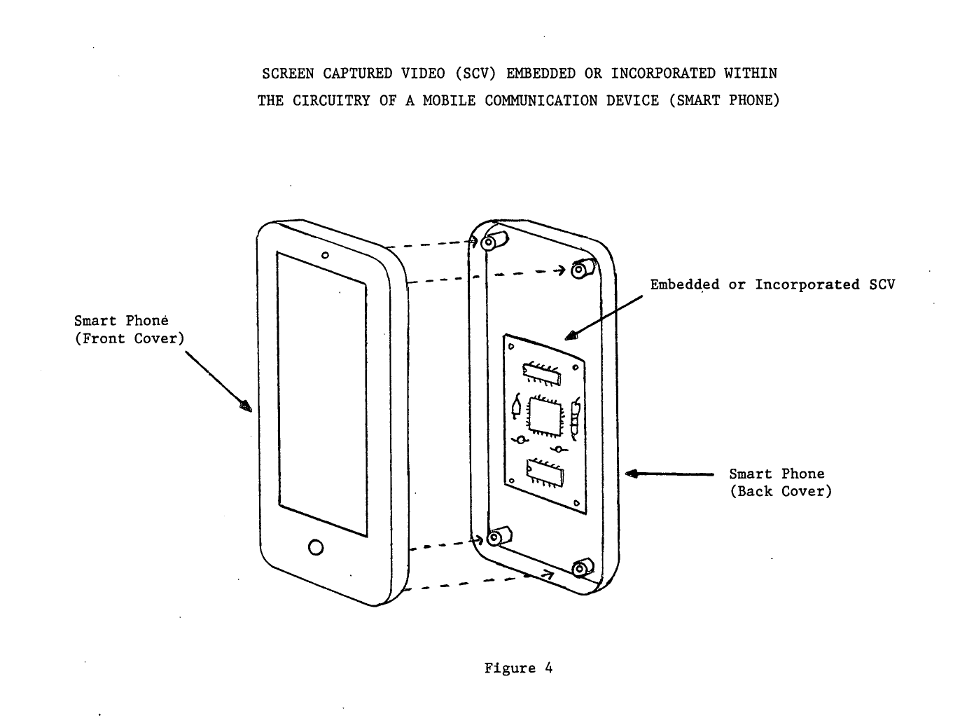

### DETAILED DESCRIPTION OF THE INVENTION

The Screen Capture Video (SCV) is a system for mobile communications that enables a mobile communication device such as, a smart phone, cell phone, tablet, or smart watch, to capture and store/record the user's activities, sessions, or events. And, once activated, the SCV will run in the background of the user's current activity or event being worked on or used on the mobile communication device. Therefore, enabling said mobile communication device to capture and store/record the user's complete activities, sessions, or events, online or offline, for later uses. The user of the mobile communication device my capture his or her activities while working with or navigating through a program, application, game, or any other types of activities. Then, revisit these captured/recorded sessions for later viewing or editing, which includes cropping, cutting and pasting of other materials, adding graphics or text, deleting of certain sections or parts, adding additional sound and video; and in the case of a captured training session, the user may add special features, tools, or effects such as, pointing arrows or highlighting to identify or emphasize certain or important sections, features, or preferences of the captured/recorded training session. The capturing/recording sessions will continue until the user deactivates the SCV or the user terminates his or her activities. The captured/recorded sessions will be temporary stored in a file on the user's mobile communication device. The user may playback or view, or perform whatever editing tasks or functions to the captured session directly on the user's mobile communication device, then store it permanently in a file on the mobile communication device, or the user may upload the temporarily stored captured/recorded file to the SCV's platform, server, or network. Once uploaded, the user will have other options and advance editing tools to find tune or further edit the captured/recorded session such as, adding sound effects, graphics, clip art, photo galleries, etc.

The features and functions of the SCV may be installed or programmed within a mobile communication device.

The SCV may be a circuit that is embedded or incorporated within the circuitry of a mobile communication device.

The SCV may be an independent stand along electronic device that is attached to a mobile communication device by a connection means such as, a USB connector; or may be attached by a wireless connection means such as, BLUETOOTH or WIFI.

The SCV's program or software may be a part of, or incorporated within, the operating system (utility files) of a mobile communication device to produce and control the functions and features of the SCV.

The SCV will also enable the user of a mobile communication device to activate the mobile communication device's camera and microphone, while capturing/recording a session, to permit the user to add live audio or live video narration, or a combination of both, to the captured/recorded session.

For the purposes herein, a mobile communication device shall include, a smart phone, cell phone, laptop, tablet, mobile computer, smart watch, and a wearable communication device.

Unlike today's technology for mobile communication devices, the SCV will allow full Screen Capture Video of a complete session or activity on a mobile communication device. Whether the user is working within a software program or app, or simply playing a video game, the SCV will capture/record it all, permits the user to save the captured/recorded session to a file, or to upload the captured/recorded session to a network, platform, or server. And, allows the user of the mobile communication device to view (replay), and editing all captured/recorded sessions directly on the mobile communication device.

We claim:

1) A mobile communication system comprising:
(a) a mobile communication device;
(b) an activation and deactivation means for starting and stopping said mobile communication system, and providing a software program comprising: (i) a step for creating and displaying an icon, button, or selection point on the screen of said mobile communication device for said activation and deactivation means, (ii) a step for enabling said mobile communication system to run in the background of the current activities, sessions, or events currently in use on said mobile communication device;
(c) a connection means for connecting said mobile communication system to a mobile communication device, platform, network, or server, and providing a software program to control and instruct said connection means;
(d) a file storage means for storing captured and recorded user activity, and providing a software program to control and instruct said file storage means;
(e) a means for capturing and recording user activities, sessions, and events, and providing a software program comprising: (i) a step for creating and displaying an icon, button, or selection point for starting said capturing and recording process, (ii) a step for displaying an indication to alert that said capturing or recording is in process, (iii) a step for displaying an indication to alert that said capturing or recording has discontinued;
(f) a communication means for uploading captured and recorded user activities, sessions, and events, and providing a software program to instruct and control said communication means;
(g) a means to replay and view captured and recorded user activities, sessions, and events, and providing a software program comprising: (i) a step for creating and displaying an icon, button, or selection point to enabling replay of said captured and recorded activities, sessions, and events, (ii) a step for creating and displaying an indication for said replay and view of said captured and recorded user activities, sessions, and events;
(h) a means for editing and manipulating captured and recorded user activities, sessions, and events, and providing a software program comprising: (i) step for creating and displaying an icon, button, or selection point to enabling said means for editing and manipulating captured and recorded user activates, sessions, and events.

2) The mobile communication system of claim 1, and said mobile communication system is a circuit that is embedded within the circuitry of said mobile communication device.

3) The mobile communication system of claim 1, and said mobile communication system is an electronic device that is capable of being attached to said mobile communication device.

4) The mobile communication system of claim 1, and said mobile communication device is a smart phone.

5) The mobile communication system of claim 1, and said mobile communication device is a cell phone.

6) The mobile communication system of claim 1, and said mobile communication device is a laptop.

7) The mobile communication system of claim 1, and said mobile communication device is a mobile computer.

8) The mobile communication system of claim 1, and said mobile communication device is a tablet.

9) The mobile communication system of claim 1, and said mobile communication device is a smart watch.

10) The mobile communication system of claim 1, and said connection means is wireless.

11) The mobile communication system of claim 1, and said file storage means is the memory and file storage means within said mobile communication device.

12) The mobile communication system of claim 1, and said file storage means is a platform, network, or server.

13) The mobile communication system of claim 1, and said communication means is capable of uploading files to a platform, network, or server, and capable of executing programs and applications on said platform, network, or server.

14) The mobile communication system of claim 1, and said mobile communication device is programmed with software, utility files, or applications to perform the features and functions of said mobile communication system.
